(19) United States
(12) Patent Application Publication
(10) Pub. No.: US 2013/0307190 A1
(43) Pub. Date: Nov. 21, 2013

(54) MOLD CLAMPING DEVICE AND MOLDED PRODUCT EJECTING METHOD

(71) Applicant: Koji Nagatomi, Yamaguchi (JP)

(72) Inventor: Koji Nagatomi, Yamaguchi (JP)

(73) Assignee: UBE MACHINERY CORPORATION, LTD., Yamaguchi (JP)

(21) Appl. No.: 13/977,462

(22) PCT Filed: Dec. 16, 2011
(86) PCT No.: PCT/JP2011/079196

§ 371 Date: Jul. 11, 2013

(30) Foreign Application Priority Data
Dec. 28, 2010 (JP) 2010-291436

(51) Int. Cl. B29C 45/40

(52) U.S. Cl. CPC B29C 45/4005
USPC 264/328.1; 425/595

(57) ABSTRACT

Provided is a mold clamping device that saves a space, has a light machine weight and requires low manufacturing cost in an injection molding machine, a diecast machine, and the like. The mold clamping device includes: a stationary platen having a stationary mold; a movable platen having a movable mold; a plurality of tie bars supported by the stationary platen; end blocks provided in the same number as the tie bars, which is penetrated by the tie bars and coupled with the movable platen with toggle link mechanisms; split nuts supported by the end blocks and capable of being engaged with and disengaged from the tie bars; a mold opening-closing drive unit for opening and closing the movable platen, the end blocks, and the toggle link mechanisms; and a cross head for operating the toggle link mechanisms to generate a mold clamping force.

### TECHNICAL FIELD

The invention relates to a mold clamping device used for, for example, an injection molding machine for molding plastic parts, a diecast machine for casting aluminum parts, and the like.

### BACKGROUND ART

A function for opening and closing molds at a high speed and a function capable of loading a large mold clamping force in a state that the molds are closed are required to a mold clamping device of an injection molding machine, a diecast machine, and the like. A structure of the mold clamping device mainly has three types, i.e., a direct pressure type, a toggle link type, and a composite type. The direct pressure type is a system for executing both a mold opening-closing operation and a mold clamping operation by a single hydraulic cylinder having a large diameter. The toggle link type is a system for executing both a mold opening-closing operation and a mold clamping operation by a toggle link mechanism and a hydraulic cylinder having a small diameter. The composite type is a system for executing a mold opening-closing operation by a long hydraulic cylinder having a small diameter and clamping molds by a short hydraulic cylinder having a large diameter after a lock device has been operated succeeding to the mold opening-closing operation. Further, the mold clamping device mainly has a hydraulic drive type and an electric drive type. The hydraulic drive type executes the mold opening-closing operation and the mold clamping operation by moving a piston rod forward and backward by supplying a high pressure hydraulic oil discharged from a hydraulic pump to a hydraulic cylinder, and the like. The electric drive type executes the mold opening-closing operation and the mold clamping operation by converting rotating motion of a servo motor to linear motion by a ball screw. The electric drive type has an excellent feature in that it saves energy consumption, is excellent in a control performance, and is low in noise. In contrast, since the electric drive type cannot generate a too large force, the mold clamping device employs a toggle link type having boost characteristics capable of producing a large force by a small force.

Known as an electric drive type mold clamping device employing the toggle link type are mold clamping devices described in, for example, Patent Literature 1 (JP 2000-110901 A) and Patent Literature 2 (JP 2001-300998 A).

The mold clamping device of Patent Literature 1 includes a stationary platen and an end plate, a movable platen disposed so as to be able to move between the stationary platen and the end plate in a mold opening-closing direction, a toggle link mechanism for coupling the end plate with the movable platen, and a cross head for stretching and contracting the toggle link mechanism. The mold clamping device of the Patent Literature 1 moves the movable platen in a mold opening-closing direction by stretching and contracting the toggle link mechanism, thereby executing both the mold opening-closing operation and the mold clamping operation.

The mold clamping device of Patent Literature 2 includes a stationary platen fixed to a base, an end platen disposed so as to be able to move in a mold opening-closing direction with respect to the stationary platen, a mold opening-closing ball screw for coupling the end platen with the stationary platen and moving the end platen in the mold opening-closing direction with respect to the stationary platen, a movable platen disposed so as to be able to move between the stationary platen and the end platen in the mold opening-closing direction, a mold clamping toggle link mechanism for coupling the end platen with the movable platen, and a cross head for stretching and contracting the mold clamping toggle link mechanism. The mold clamping device of the Patent Literature 2 is configured to execute a mold opening-closing operation by the mold opening-closing ball screw and to execute a mold clamping operation of molds by the mold clamping toggle link mechanism. That is, the mold clamping device of Patent Literature 2 is configured to move the end platen in the mold opening-closing direction by driving the mold opening-closing ball screw, thereby executing the mold opening-closing operation by moving the movable platen coupled via the mold clamping toggle link mechanism in the mold opening-closing direction. Further, the mold clamping device of Patent Literature 2 moves the movable platen in the mold opening-closing direction with respect to the end platen by stretching and contracting the mold clamping toggle link mechanism, thereby executing the mold clamping operation.

### CITATION LIST

### Patent Literatures

Patent Literature 1: JP 2000-110901 A

Patent Literature 2: JP 2001-300998 A

### SUMMARY OF INVENTION

### Technical Problem

However, since the mold clamping device of Patent Literature 1 executes the mold opening-closing operation by the toggle link mechanism, it is necessary to use a large toggle link mechanism. Accordingly, the mold clamping device of Patent Literature 1 has a problem in that since a length of the device in the mold opening-closing direction becomes very long, a large foot print is necessary. Further, since the mold clamping device of Patent Literature 2 moves the end platen whose weight is very large in the mold opening-closing direction, a problem arises in that an operation for moving the end platen in the mold opening-closing direction lacks accuracy. Further, since the end plate (end platen) of any of the mold clamping devices of Patent Literatures 1 and 2 is heavy, there is a problem in that the mold clamping devices are heavy in weight.

An object of the invention is to provide a mold clamping device that saves a space and has a light weight and an ejecting method using the mold clamping device.

### Solution to Problem

To solve the problem described above, a mold clamping device according to the invention includes a stationary platen having a surface to which a stationary mold can be mounted, a movable platen having a surface to which a movable mold can be mounted, and the surface to which the movable mold can be mounted faces the surface to which the stationary mold of the stationary platen can be mounted, a plurality of tie bars supported by the stationary platen and passing through the movable platen, a plurality of end blocks each having at least one of split nuts capable of being engaged with and disengaged from one of the tie bars, a plurality of mold clamping toggle link mechanisms at least one of which is provided to each of the end blocks and which couple the end blocks with the movable platen, a cross head provided coupled with the mold clamping toggle link mechanisms for stretching and contracting the mold clamping toggle link mechanisms, and a mold opening-closing drive unit for moving the movable platen in a mold opening-closing direction with respect to the stationary platen, wherein each of the end blocks is provided to each of the tie bars or provided to two or more adjacent tie bars of the tie bars.

In a mold clamping device according to the invention, the stationary platen and the movable platen may be formed in a rectangular shape and the plurality of tie bars may be supported at four corners of the stationary platen and provided passing through four corners of the movable platen.

In a mold clamping device according to the invention, at least one of the mold clamping toggle link mechanisms may be provided to each of the end blocks.

In a mold clamping device according to the invention, the cross head may be supported by the movable platen and may include an ejector pin projecting toward the movable platen, the movable platen may have a hole through which the ejector pin can pass at a position aligned with the ejector pin, and the ejector pin may pass through the hole and may project from the movable platen by that the cross head moves in the direction of the movable platen and approaches the movable platen.

A mold clamping device according to the invention may further include a machine base, and a support member provided on the machine base for supporting the movable platen movably in the mold opening-closing direction with respect to the machine base, wherein the mold opening-closing drive unit may directly couple the movable platen with the machine base or may indirectly couple the movable platen with the machine base via the support member and may move the movable platen in the mold opening-closing direction with respect to the stationary platen by moving the movable platen in the mold opening-closing direction with respect to the machine base.

A mold clamping device according to the invention further may include a coupling support member for coupling two or more end blocks of the end blocks with each other.

Further, a molded product ejecting method according to the invention is a molded product ejecting method executed using a mold clamping device according to the invention, the method including a mold mounting step of mounting a stationary mold to the stationary platen and mounting a movable mold to the movable platen, a mold closing step of moving the movable platen in the direction of the stationary platen by the mold opening-closing drive unit and closing the stationary mold and the movable mold, an engaging step of engaging the tie bars with the end blocks by operating the split nuts, respectively after the mold closing step, a mold clamping step of stretching the mold clamping toggle link mechanisms by moving the cross head in the direction of the end blocks after the engaging step and generating a mold clamping force between the stationary platen and the movable platen, a molding step of molding a molded product in a mold cavity formed by the stationary mold and the movable mold after the mold clamping step, a mold clamp releasing step of contracting the mold clamping toggle link mechanisms by moving the cross head in the direction of the movable platen after the molding step and releasing the molds clamped between the stationary platen and the movable platen, an engagement releasing step of operating the split nuts, respectively after the mold clamp releasing step and disengaging the tie bars from the end blocks, a mold opening step of moving the movable platen in the direction of the end blocks by the mold opening-closing drive unit in a state that the molded product is held by the movable mold after the engagement releasing step and opening the stationary mold and the movable mold, and an ejecting step of projecting the ejector pin of the cross head from the hole of the movable platen by moving the cross head in the direction of the movable platen while the mold opening step is continued or after the mold opening step and ejecting the molded product held by the movable mold by the ejector pin.

### Advantageous Effects of Invention

According to the invention, a mold clamping device capable of saving a space and having a light weight and an ejecting method using the mold clamping device can be provided.

### BRIEF DESCRIPTION OF DRAWINGS

FIG. 1 is a view illustrating a mold clamping device of the invention of the application and illustrates a state that molds are opened.

FIG. 2 is a view illustrating a toggle link mechanism in detail.

FIG. 3 is a view of the toggle link mechanism when it is observed from a movable platen side.

FIG. 4 is a view of a stationary plate of the toggle link mechanism when it is observed from an end block side.

FIG. 5 is a view of the stationary platen when it is observed from an injection device side and illustrates a rotation/drive unit of stationary nuts, and the like.

FIG. 6 is a view illustrating a state that a split nut is opened.

FIG. 7 is a view illustrating that the split nut is closed and engaged with a tie bar.

FIG. 8 is a view illustrating the mold clamping device in a state that the molds are closed and a mold clamping force is loaded.

FIG. 9 is a view illustrating the toggle link mechanism when it is in a stretched state.

FIG. 10 is a view illustrating the toggle link mechanism when it is in a state that ejector pins project.

FIG. 11 is a view of the molds illustrating a state that they are closed.

FIG. 12 is a view illustrating a mold clamping device in a second embodiment of the invention of the application.

FIG. 13 is a view illustrating a toggle link mechanism in a third embodiment of the invention of the application when it is observed from a movable platen side.

### DESCRIPTION OF EMBODIMENTS

A best mode for carrying out the invention will be explained in detail referring to drawings.

### First Embodiment

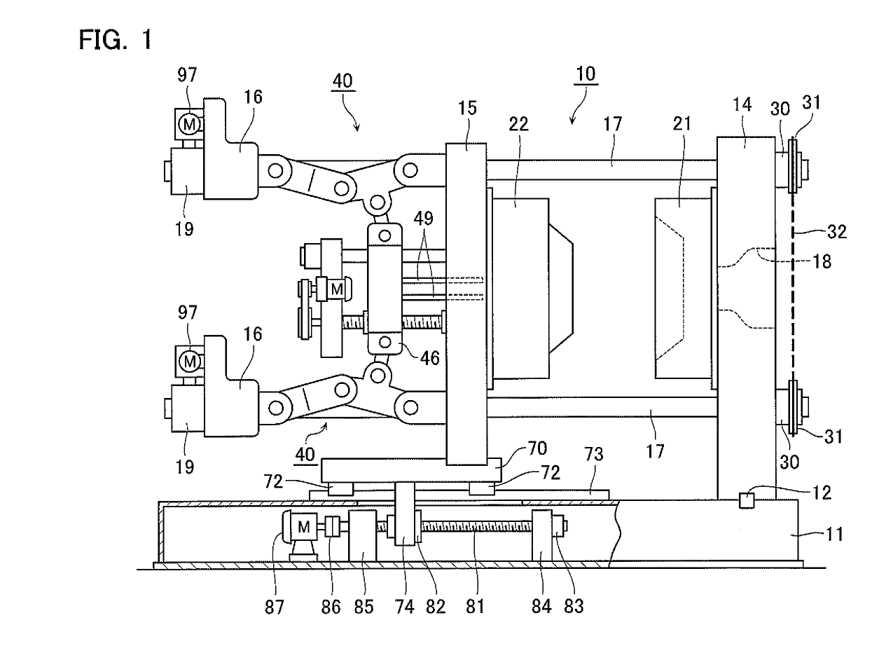

FIG. 1 illustrates an overall mold clamping device in a first embodiment of the invention of the application. The mold clamping device 10 according to the first embodiment mainly includes a stationary platen 14 having a surface to which a stationary mold 21 can be mounted, a movable platen 15 having a surface to which a movable mold 22 can be mounted, four tie bars 17 supported by the stationary platen 14 and passing through the movable platen 15, four end blocks 16 each of which is disposed to each of the four tie bars, mold clamping toggle link mechanisms 40, two each of which are disposed to each of the four end blocks 16, a cross head 46 for stretching and contracting all the toggle link mechanisms 40, and a mold opening-closing drive unit for moving the movable platen 15 in a mold opening-closing direction with respect to the stationary platen 14.

A lower portion of the mold clamping device 10 is supported by a machine base 11 installed on a floor surface. The rectangular stationary platen 14 is placed on the machine base 11 in a state that it is fixed via stationary keys 12. The stationary mold 21 is mounted to a front surface (a surface facing a left side in FIG. 1) of the stationary platen 14.

Further, the rectangular movable platen 15 is disposed to a front surface side (left side in FIG. 1) of the stationary platen 14. The movable mold 22 is mounted to a front surface of the movable platen 15 (a surface facing a right side in FIG. 1). A lower portion of the movable platen 15 is fixed on a slide table 70. Slide blocks 72 are attached to a lower side of the slide table 70. The slide blocks 72 are disposed on slide rails 73 attached to the machine base 11. Since a rolling member such as a sphere, a cylindrical roller, and the like is assembled between the slide blocks 72 and the slide rails 73, the slide table 70 and the movable platen 15 can smoothly execute sliding motion (opening-closing operation) on the machine base 11. Note that, in the mold clamping device according to the embodiment, although a support member (sliding member) for supporting the movable platen 15 on the machine base 11 is explained as the slide table 70, the slide blocks 72, and the slide rails 73, various modes can be employed without being restricted to the mode described above. For example, the support member for supporting the movable platen 15 on the machine base 11 may be a shoe stretched over a predetermined region on the machine base 11. In the case, the movable platen 15 slides on the shoe and moves in the mold opening-closing direction. Further, the support member for supporting the movable platen 15 on the machine base 11 may have, for example, concave guide rails disposed on the machine base 11 and shoes disposed to concave portions of the concave guide rails. In the case, convex portions having a shape matched to the concave portions of the concave guide rails are disposed to a bottom portion of the movable platen 15. The movable platen 15 moves in the mold opening-closing direction by that the convex portions of the movable platen 15 slide on the shoes as well as the movable platen 15 is guided by the concave portions of the concave guide rails so as to move in the mold opening-closing direction.

The four end blocks 16 are disposed on a back surface side (left side in FIG. 1) of the movable platen 15 via eight sets of the toggle link mechanisms 40. A cylindrical bush is assembled inside of each end block 16, and a tie bar 17 passes through inside of the bush with a slight clearance. Although a weight of each end block 16 is supported by the tie bar 17, since a lubricant is supplied inside of the bush, the end block 16 can smoothly slide along the tie bar 17. Further, when a mold clamping force is increased by moving the toggle link mechanisms 40, although a rotational force acts on the respective end blocks 16 via large diameter link pins 47, since the respective end blocks 16 are supported by the tie bars 17 via the bushes, respectively, a rotation in the mold opening-closing direction is regulated by the tie bars 17, the respective end blocks 16 are not rotated in the mold opening-closing direction. Further, a mold clamping operation, a mold releasing operation, an ejecting operation to be described later can be executed by operating the toggle link mechanisms 40. Each end block 16 has a split nut 19 capable of being engaged with and disengaged from (released from engagement with) the tie bar 17. The mold clamping device 10 can produce the mold clamping force in a state that the respective tie bars 17 are engaged with the respective split nuts 19 (the respective end blocks 16).

The four tie bars 17 pass through the four corners of each of the stationary platen 14 and the movable platen 15. The four tie bars 17 are supported to the stationary platen 14 by stationary nuts 30.

The stationary platen 14 has an injection hole 18 formed through a central portion thereof, so that a not illustrated injection device can be inserted therethrough. The injection device is provided with a mechanism for melting plastic and aluminum and injecting a desired amount of a molten material into the molds and filling the molds with the molten material. In a state that a molten material inlet of the stationary mold 21 is in touch with an extreme end portion of the injection device, the molten material is injected into and filled in a mold cavity and cooled and solidified, thereby the molten material can be molded to a molded product having a desired shape.

The mold opening-closing drive unit is attached inside of the machine base 11. The mold opening-closing drive unit includes a mold opening-closing ball screw shaft 81, a mold opening-closing ball screw nut 82, an electromagnetic brake 83, a support block 84, a stationary block 85, a coupling 86, and a mold opening-closing servo motor 87. The mold opening-closing ball screw shaft 81 is supported in the stationary block 85 fixed to the machine base 11 in a state that it is rotatable via a bearing and restricted in an axis direction. Further, the vicinity of an extreme end portion of the mold opening-closing ball screw shaft 81 (vicinity of a right end in FIG. 1) is rotatably supported by the support block 84 via a bearing. The extreme end portion of the mold opening-closing ball screw shaft 81 (right end in FIG. 1) is coupled with the electromagnetic brake 83 attached to the support block 84 and can execute an emergency stop of a mold opening-closing operation, and the like. The mold opening-closing ball screw shaft 81 is rotated by releasing the electromagnetic brake 83 by turning on it. A base end of the mold opening-closing ball screw shaft 81 (left side in FIG. 1) is coupled with a rotating shaft of the mold opening-closing servo motor 87 via the coupling 86. With the configuration, the rotating shaft of the mold opening-closing servo motor 87 is rotated integrally with the mold opening-closing ball screw shaft 81. The mold opening-closing ball screw nut 82 threaded onto the mold opening-closing ball screw shaft 81 is attached to a coupling block 74 fixed to a lower portion of the slide table 70. With the configuration, when a rotation command is electrically transmitted from a not illustrated controller to the mold opening-closing servo motor 87, the mold opening-closing ball screw shaft 81 is rotated, so that the slide table 70, the movable platen 15, the end blocks 16, and the toggle link mechanisms 40 can be opened and closed by an operation of a ball screw. Note that in the mold clamping device of according to the embodiment, although it is explained that the mold opening-closing drive unit indirectly couples the movable platen 15 with the machine base 11 via the support member (the slide table 70, the slide blocks 72, and the slide rails 73), the mold clamping device is not limited thereto. That is, in, for example, a mold clamping device of a type for sliding the movable platen 15 on shoes disposed on the machine base 11, the mold opening-closing drive unit directly couples the movable platen 15 with the machine base 11.

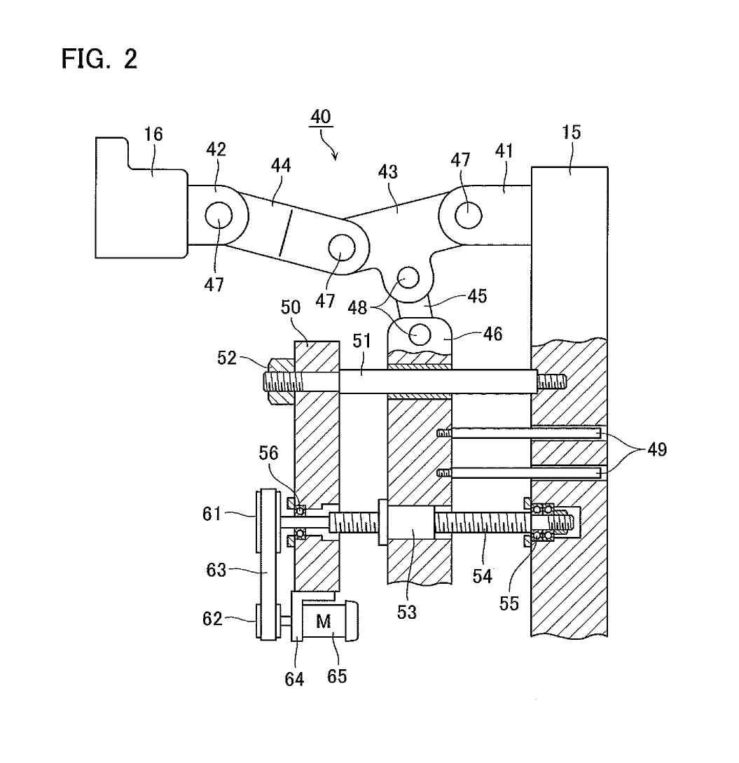

FIG. 2 illustrates each toggle link mechanism 40 in detail. The toggle link mechanism 40 is coupled between the movable platen 15 and the end block 16.

A movable side link member 41 is formed integrally with the movable platen 15 and provided with a hole into which a large diameter link pin 47 is inserted. Likewise, an end side link member 42 is formed also integrally with the end block 16 and provided with a hole into which a large diameter link pin 47 is inserted. A right link 43 is coupled with the movable side link member 41 via the large diameter link pin 47 and can make rotating motion about the large diameter link pin 47. Further, a left link 44 is coupled with the end side link member 42 via the large diameter link pin 47 and can make rotating motion about the large diameter link pin 47. Further, the right link 43 is coupled with the left link 44 via a large diameter link pin 47. The holes of the right link 43 and the left link 44 into which the large diameter link pins 47 are inserted are assembled with bushes disposed inside thereof, so that the right link 43 and the left link 44 can be smoothly turned.

A guide rod 51 is fixed to the movable platen 15. The cross head 46 has a hole formed thereto through which the guide rod 51 passes therethrough, so that the cross head 46 can slide to right and left by being guided by the guide rod 51. The cross head 46 is coupled with the right link 43 via a cross head link 45 and small diameter link pins 48. Ejector pins 49 are fixed to the cross head 46 and inserted into holes passing through the movable platen 15. With the configuration, when the cross head 46 is moved to right and left, a distance between the movable platen 15 and the end block 16 can be changed by an operation of the toggle link mechanism 40. Further, it is also possible to project and retract the ejector pins 49 to and from a mold mounting surface of the movable platen 15. Since the ejector pins 49 are differently disposed depending on a mold to be used and a product to be molded, a lot of attachment structures of the ejector pins 49 are previously prepared to the cross head 46 to cope with many molds and products. To make it easy to cope with a change of disposition of the ejector pins corresponding to a change of a mold and a product or to cope with a damage, a maintenance, and the like of the ejector pins, an ejector pin unit in which ejector pins are appropriately disposed on a plate-like member may be previously prepared to each mold or product and the ejector pins may be replaced together with the ejector pin unit.

A stationary plate 50 is attached to the guide rod 51 by a guide rod nut 52. A link unit ball screw shaft 54 is rotatably assembled to the movable platen 15 by a link portion bearing 55 in a state that it is restricted in the axis direction. A link portion ball screw nut 53 that is threaded onto the link portion ball screw shaft 54 is fixed to the cross head 46, and a base end side of the link portion ball screw shaft 54 (left side in FIG. 2) is rotatably supported to a stationary plate 56 by a link portion support shaft receiver 56. Further, a large pulley 61 is fixed to a base end portion of the link portion ball screw shaft 54 (left end in FIG. 2). A drive servo motor 65 is attached to a lower side of the stationary plate 50 by a motor bracket 64. Note that, in FIG. 1, although the drive servo motor 65 is attached to a lateral side of the stationary plate 50, it is drawn on a lower side in FIG. 2 to make its configuration easily understandable. A small pulley 62 is attached to a rotating shaft of the drive servo motor 65 and can transmit rotating motion to the large pulley 61 by a toothed belt 63. With the configuration, when the rotating shaft of the drive servo motor 65 is driven in rotation in response to a command from the controller, the link portion ball screw shaft 54 is rotated, so that the cross head 46 can be moved in the mold opening-closing direction (right-left direction in FIG. 2) by an operation of the ball screw.

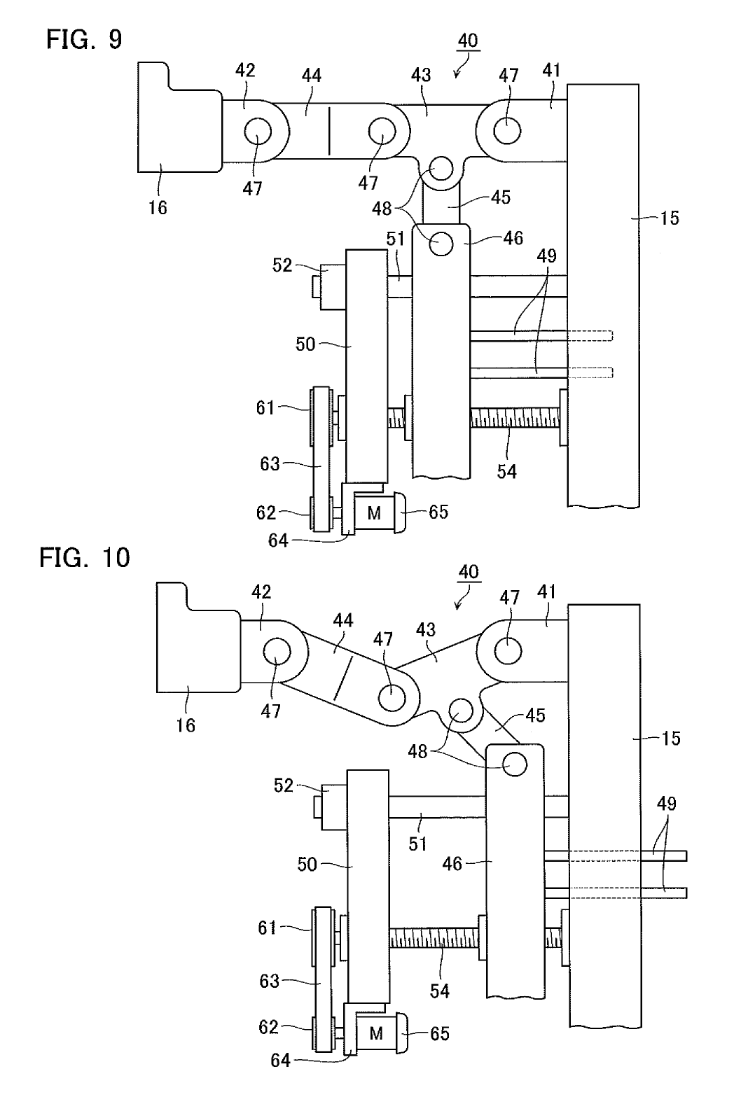

In FIG. 2, top surfaces of the ejector pins 49 are located at positions recessed 2 mm from the mold mounting surface of the movable platen 15, this state being an original position of the cross head 46. The toggle link mechanism 40 is designed so that the cross head 46 can move from the original position to a right side 102 mm when it is assumed that a maximum projection amount of the ejector pins 49 is, for example, 100 mm. Further, the toggle link mechanism 40 is designed so that when a mold releasing (forcible mold opening) stroke is 20 mm and an elongation amount of the tie bar 17 is 5 mm when a maximum mold clamping force is produced in a state that a mold having a maximum thickness is mounted, the cross head 46 moves from the original position state to the end block 16 side (left side in FIG. 2), the movable platen 15 is away 25 mm from the end block 16 as well as the three large diameter link pins 47 are arranged side by side on a straight line at the time as shown in FIG. 9.

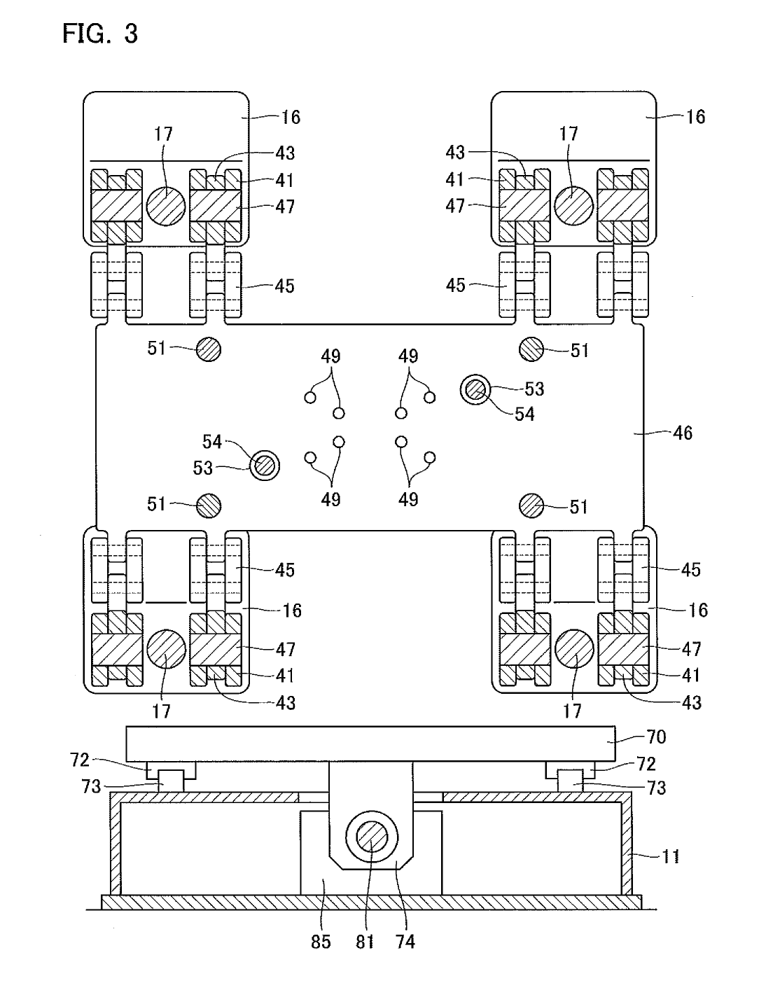

FIG. 3 is a view when a cross section taken along a center line of the large diameter link pins 47 inserted into the movable side link members 41 is observed from the movable platen 15. The four tie bars 17 and the four end blocks 16 that are not illustrated in FIG. 1 are disposed at four corners. Each two sets of the movable side link members 41 are disposed on the right and left sides of each tie bar 17, i.e., the four sets of the movable side link members 41 are disposed in the vicinity of each tie bar, that is, 16 sets in total of the movable side link members 41 are attached. The right link 43 of a number of one is coupled between the movable side link members 41 of a number of each two via a large diameter link pin 47. Further, two sets of the cross head links 45 are disposed on both the sides of one set of the right link 43 are coupled with the cross head 46 via small diameter pins 48. The cross head 46 is slidably supported by four pieces of the guide rods 51 as well as assembled with two pieces of the link portion ball screw shaft 54 and two pieces of the link portion ball screw nut 53. Further, eight pieces of the ejector pins 49 are fixed to the cross head 46. In FIG. 3, there may be employed a mode in which the right links 43 and the left links 44 (refer to FIG. 2) and the cross head links 45 that are adjacent to each other across each tie bar 17 are coupled with each other by different members in a direction orthogonal to an axis direction of the tie bar 17 and a mode in which the respective toggle link mechanisms 40 that are disposed across each tie bar 17 are disposed on any one side (on a right side or a left side of the tie bar 17 in FIG. 3) depending on a size of the mold clamping device.

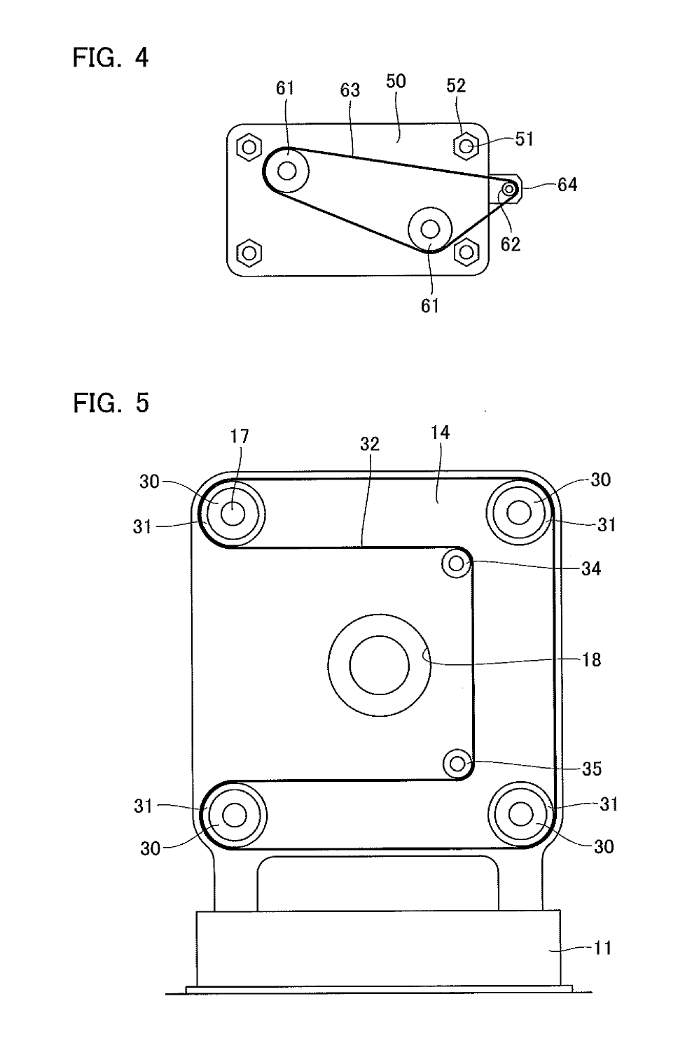

FIG. 4 is a view of the stationary plate 50 in FIG. 2 when it is observed from the end block 16 side. The stationary plate 50 is fixed to the four guide rods 51 by the guide rod nuts 52. The small pulley 62 attached to the rotating shaft of the drive servo motor 65 is coupled with two pieces of the large pulley 61 attached to ends of two pieces of the link portion ball screw shaft 54 by the toothed belt 63, so that rotating motion of the small pulley 62 can be transmitted to the two large pulleys 61.

In FIG. 1, chain sprockets 31 are attached in the peripheries of stationary nuts 30, and a chain 32 coupled with the chain sprockets 31. Although the stationary nuts 30 can rotate with respect to the stationary platen 14, the stationary nuts 30 are supported so as not to be separated from the stationary platen 14 even if they are applied with a mold releasing force.

FIG. 5 is a view illustrating the stationary platen 14 in FIG. 1 when it is observed from the injection device side (right side in FIG. 1). The four tie bars 17 are screw coupled with four pieces of the stationary nuts 30, respectively. The single chain 32 coupled with the chain sprockets 31 attached to the stationary nuts 30. An idler sprocket 34 is rotatably attached to the stationary platen 14. Further, a motor sprocket 35 is attached to a rotating shaft of a motor fixed to the stationary platen 14, and a chain 35 can be moved by rotating the motor. Each tie bar 17 is attached with a not illustrated detent, thereby the tie bar 17 can be moved in the axis direction by driving the stationary nuts 30 in rotation via the chain 32. As described above, adjusting a position of the tie bar 17 in the axis direction allows the tie bar 17 to be moved to a position where the meshing teeth of the tie bar 17 are just meshed with the meshing teeth of the split nut 19 on the end block 16 side. It is sufficient that a movable stroke of the tie bar 17 is one pitch of the teeth of the tie bar 17 to be meshed with the meshing teeth of the split nut 19. Further, the rotation of the stationary nut 30 is suppressed by applying a brake to the motor for rotating the motor sprocket 35, so that the stationary platen 14, the stationary nuts 30, and the tie bars 17 are integrally configured.

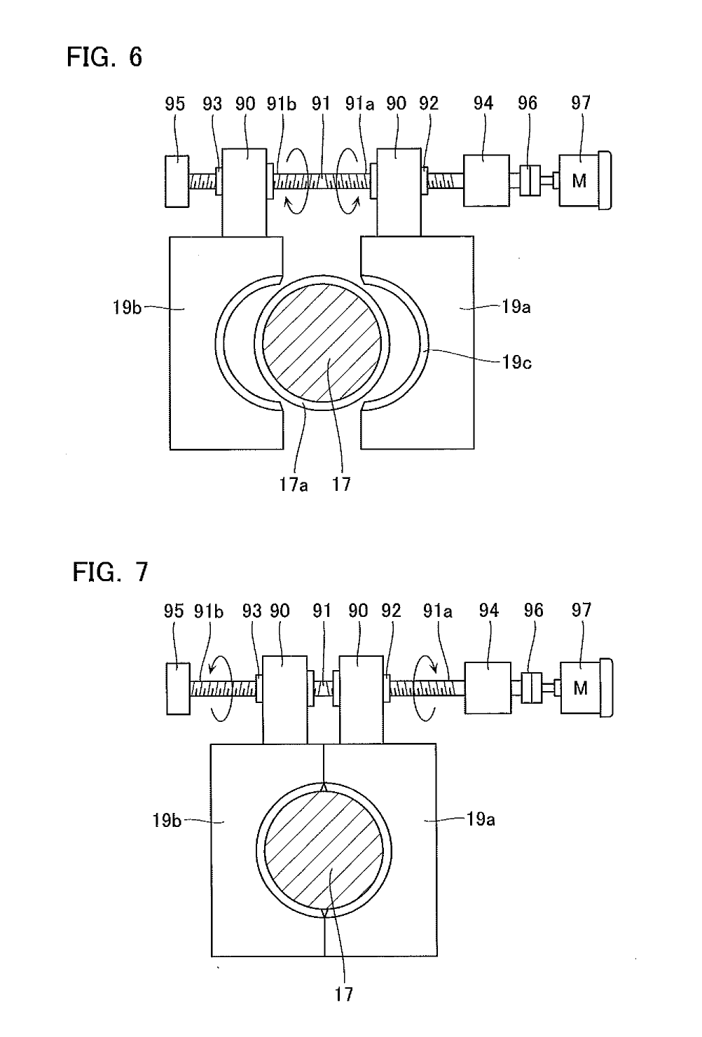

FIG. 6 is a view of the split nut 19 in FIG. 1 when it is observed from a left side in FIG. 1. In a state illustrated in FIG. 6, the split nut 19 is opened and the tie bar 17 is disengaged from the split nut 19. A tie bar engaging groove 17a is formed at a position around an outer circumference of the tie bar 17 where the tie bar 17 is meshed with the split nut 19 (a mesh position in agreement with a thickness of the mold). The tie bar engaging groove 17a is a saw-tooth shaped or rectangular-wave shaped ring groove. The split nut 19 is including a right split nut 19a and a left split nut 19b. A split nut engaging groove 19c, which is engaged with the tie bar engaging groove 17a in a state that the right split nut 19a and the left split nut 19b are closed, is formed inside of the split nut 19. Although the right split nut 19a and the left split nut 19b can slide on the end block 16 in a direction orthogonal to the mold opening-closing direction (lateral direction in FIG. 6) while being in contact with the end block 16, they are supported so as not to be separated from the end block 16 even if they receive the mold releasing force. Further, split nut coupling blocks 90 are fixedly coupled with an upper surface of the right split nut 19a and an upper surface of the left split nut 19b, respectively, and a right ball screw nut 92 is attached to the right split nut 19a and a left ball screw nut 93 is attached to the left split nut 19b. Further, a stationary block 94 is fixed to the end block 16. A ball screw shaft 91 is rotatably supported inside of the stationary block 94 via a bearing in a state that it is restricted in the axis direction. A base end portion of the ball screw shaft 91 (right side end in FIG. 6) is coupled with a rotating shaft of a nut opening-closing servo motor 97 attached to the end block 16 by a coupling 96. Further, an extreme end portion of the ball screw shaft 91 (left side end in FIG. 6) is rotatably supported by a support block 95 fixed to the end block 16.

The ball screw shaft 91 is including a right screw portion 91a to which a right screw is formed and a left screw portion 91b to which a left screw is formed. In the ball screw shaft 91, the right screw portion 91a is threaded into the right ball screw nut 92 and the left screw portion 91b is threaded into the left ball screw nut 93. With the configuration, the split nut 19 opens and closes the right split nut 19a and the left split nut 19b by rotating the ball screw shaft 91 forward and backward, so that the split nut 19 is engaged with and disengaged from the tie bar 17. That is, when the ball screw shaft 91 is rotated in the directions of arrows in FIG. 6, the right split nut 19a moves to left as well as the left split nut 19b moves to right, so that they are engaged with the tie bar 17 as shown in FIG. 7. Further, when the ball screw shaft 91 is rotated in the directions of arrows of FIG. 7, the right split nut 19a moves to right as well as the left split nut 19b moves to left, so that they can be disengaged from the tie bar 17 as shown in FIG. 6.

Operation methods of opening-closing, clamping, and separating the molds (forcible mold opening) and an ejecting operation method executed by the mold clamping device 10 explained above will be explained hereinafter.

First, after the stationary mold 21 has been mounted to the stationary platen 14 and the movable mold 22 has been mounted to the movable platen 15, a mold adapting mode is executed. The mold adapting mode is a step of adjusting the positions of the four tie bars 17 in the axis direction based on the thickness of the mold mounted to the mold clamping device 10 (total thickness of the stationary mold 21 and the movable mold 22) and an elongation amount of the tie bars 17 determined by a desired mold clamping force. As a result, at mold clamping step to be described below, the desired mold clamping force is produced.

Specifically, first, in a mold open state in which the stationary mold 21 and the movable mold 22 are mounted as well as in a state that the split nut 19 is opened, that is, in a state that each end block 16 can slide on each tie bar 17, the link portion ball screw shaft 54 is rotated by the drive servo motor 65 of the stationary plate 50, so that the cross head 46 is moved in a mold opening direction by the operation by of the ball screw (left direction in FIG. 9). The cross head 46 continues to be moved until the toggle link mechanism 40 has been stretched as illustrated in FIG. 9, that is, until the right link 43 and the left link 44 have been arranged on a straight line. At the time, as the toggle link mechanism 40 stretches, the end block 16 moves on the tie bar 17 in the mold opening direction (left direction in FIG. 9). Next, the movable platen 15 is moved in a mold closing direction (right direction in FIG. 1) by operating the mold opening-closing servo motor 87 of the mold opening-closing drive unit, so that the stationary mold 21 and the movable mold 22 are closed. At the time, the thickness of the mold (total thickness of the stationary mold 21 and the movable mold 22) is measured from a value detected by a rotary encoder attached to the mold opening-closing servo motor 87. Thereafter, the controller calculates the elongation amount of the tie bars 17 based on the measured thickness of the mold and the desired mold clamping force in consideration of a Young's modulus of a tie bar material, and the like.

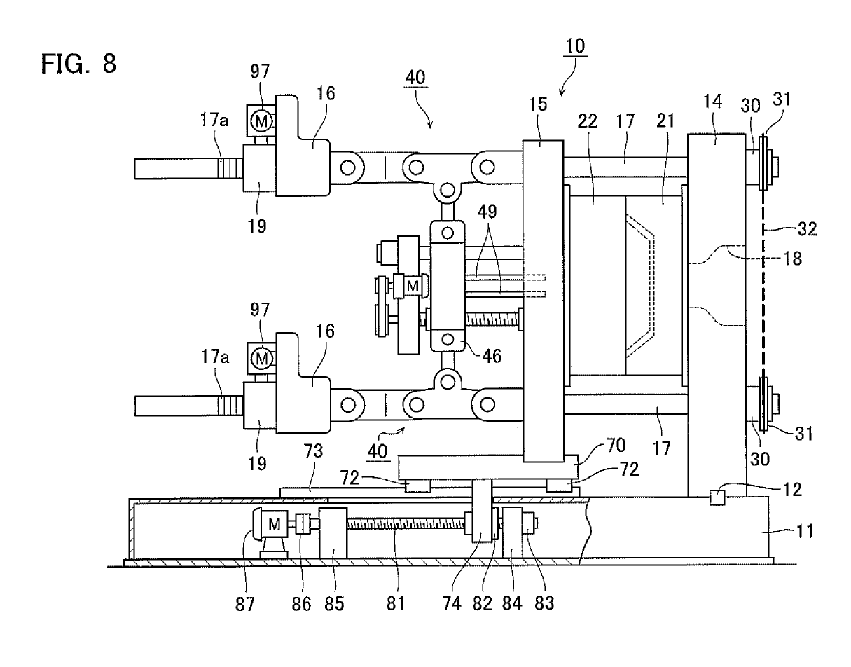

Subsequently, the motor sprocket 35 of the stationary platen 14 is rotated to thereby move the tie bar 17 from the position where the tie bar engaging groove 17a is just meshed with the split nut engaging groove 19c by the calculated elongation amount of the tie bar 17 in the mold closing direction (right direction in FIG. 8). Next, the link portion ball screw shaft 54 is rotated by the drive servo motor 65 of the stationary plate 50 while loading a force, by which the molds are closed, to the movable platen 15 by the mold opening-closing drive unit, so that the cross head 46 is moved in the mold closing direction (right direction in FIG. 10) by the operation of the ball screw. The cross head 46 continues to be moved until the toggle link mechanism 40 has been bent as illustrated in FIG. 10 and the position of the end block 16 has changed from the position where the toggle link mechanism 40 had stretched as illustrated in FIG. 9 to the position where the position of the end block 16 has approached the movable platen 15 by the elongation amount of the tie bar 17. With the operation, the position of the split nut engaging groove 16c become the position where the split nut engaging groove 16c is just meshed with the tie bar engaging groove 17a. Next, the split nut 19 is closed by operating the nut opening-closing servo motor 97 of the split nut 19, and the split nut 19 is engaged with the tie bar 17. Subsequently, the cross head 46 is moved in the mold opening direction (left direction in FIG. 8) by operating the drive servo motor 65 of the stationary plate 50. The cross head 46 continues to be moved until the toggle link mechanism 40 has been stretched as illustrated in FIG. 8. With the operation, the tie bar 17 is elongated in the axis direction thereof by the calculated elongating amount, and the set mold clamping force is loaded to the mold. At the time, it is measured whether or not a mold clamping force as large as a set value is produced using a mold clamping force sensor (strain gauge bonded on a tie bar, and the like). When a difference arises between the set value and a measured value, the mold clamping force is reduced by bending the toggle link mechanisms 40 and the position of the tie bar 17 in the axis direction is adjusted again by opening the split nut 19. When it is confirmed that the mold has been clamped again and the mold clamping force as large as the set value has been produced, the mold clamping force is reduced, the cross head 46 is returned to the original position, the split nut 19 is opened, and the movable platen 15 and the like are retracted to a mold opening position. The mold adapting mode is finished by the operations described above.

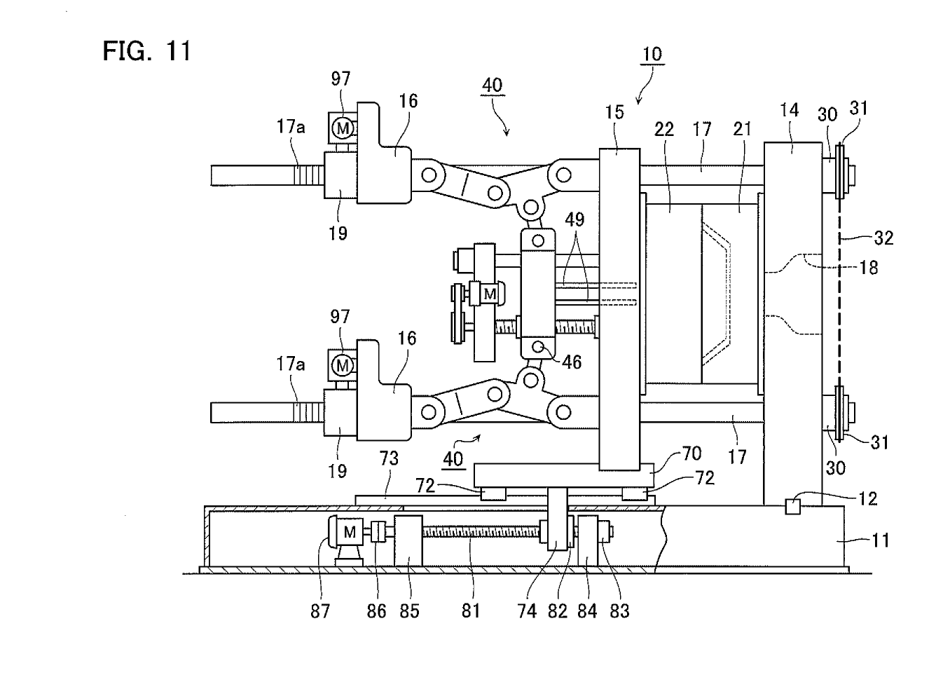

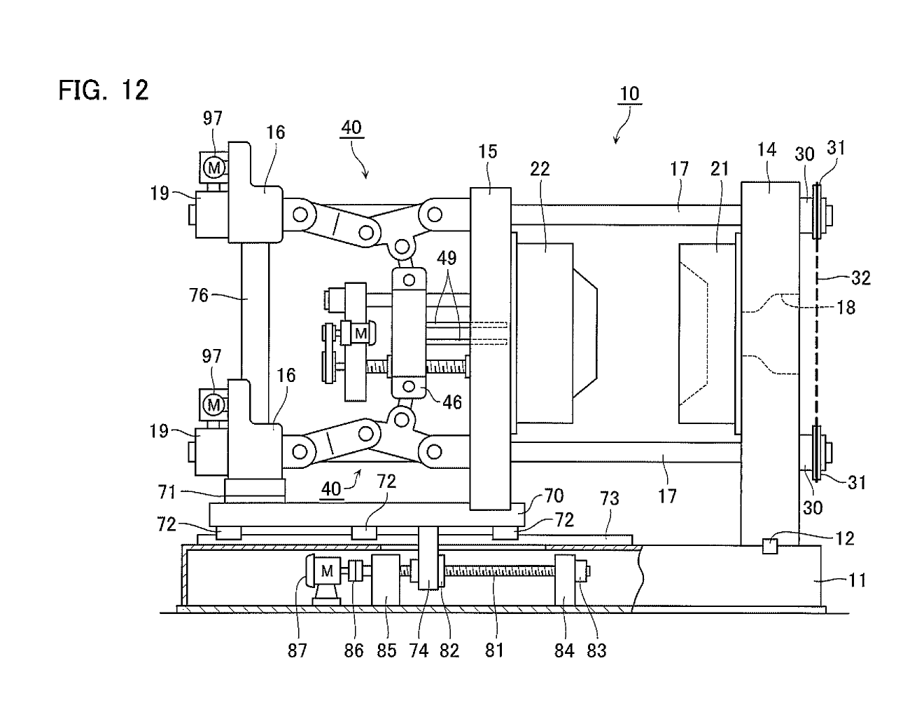

After the finish of the mold adapting mode, when a preparation for injecting and filling the molten material has been completed in the injection device, subsequently, a molding mode for producing a molded product is started. The molding mode mainly includes a mold closing step of moving the movable platen 15 in the direction of the stationary platen 14 by the mold opening-closing drive unit and closing the stationary mold 21 and the movable mold 22, an engaging step of closing the split nuts 19, respectively after the mold closing step and engaging the four tie bars 17 with the four end blocks 16, a mold clamping step of stretching the toggle link mechanisms 40 by moving the cross head 46 in the mold opening direction (left direction in FIG. 11) after the engaging step and generating a mold clamping force between the stationary platen 14 and the movable platen 15, a molding step of molding a molded product in a mold cavity formed by the stationary mold 21 and the movable mold 22 after the mold clamping step, a mold clamp releasing step of contracting the toggle link mechanisms 40 by moving the cross head 46 in the mold closing direction (right direction in FIG. 8) after the molding step and releasing the molds clamped between the stationary platen 14 and the movable platen 15, an engagement releasing step of opening the split nuts 19, respectively after the mold clamp releasing step and disengaging the four tie bars 17 from the four end blocks 16, a mold opening step of moving the movable platen 15 in the mold opening direction (left direction in FIG. 11) by the mold opening-closing drive unit in a state that the molded product is held by the movable mold 22 after the engagement releasing step and opening the stationary mold 21 and the movable mold 22, and an ejecting step of projecting the ejector pins 49 of the cross head 46 from the holes of the movable platen 15 by moving the cross head 46 in the mold closing direction (right direction in FIG. 12) while the mold opening step is continued or after the mold opening step and ejecting the molded product held in the movable mold 22 by the ejector pins 49.

Specifically, first, in the mold open state illustrated in FIG. 1, the position of the end block 16 is approached to the movable platen 15 by the elongation amount of the tie bar 17 from the position in the state that the toggle link mechanism 40 has been stretched by adjusting the position of the cross head 46 by operating the drive servo motor 65 of the stationary plate 50. Subsequently, a brake is released by turning on the electromagnetic brake 83 of the mold opening-closing drive unit. Next, as illustrated in FIG. 11, the mold opening-closing servo motor 87 of the mold opening-closing drive unit is operated, and the movable platen 15, and the like are moved in the mold closing direction (right direction in FIG. 11) in a state that the positional relation between the movable platen 15 and the end blocks 16 is kept, so that the stationary mold 21 and the movable mold 22 are closed (mold closing step). At the time, since tie bar engaging groove 17a and the split nut engaging groove 19c are located at the positions where they are just meshed with each other, the split nut 19 is closed and the tie bar 17, the split nut 19, and the end blocks 16 are engaged with each other as illustrated in FIG. 7 (engaging step). When the cross head 46 is moved in the mold opening direction (left direction in FIG. 11) by operating the drive servo motor 65 of the stationary plate 50, the toggle link mechanism 40 is stretched on a straight line as illustrated in FIG. 9 and the tie bar 17 is elongated in its axis direction by the calculated elongating amount, so that the mold clamping force as large as the set value is load to the mold as illustrated in FIG. 8 (mold clamping step).

Next, the injection device is driven, the molten material is injected into and filled in a cavity space of the molds, and an appropriate pressure is loaded to the molten material (molding step). After the molten material has been cooled and solidified and made to a solid molded product, the cross head 46 is moved in the mold closing direction (right direction in FIG. 11) as illustrated in FIG. 11 and the mold clamping force is reduced to 0 (mold clamp releasing step). Thereafter, the stationary mold 21 is separated from the movable mold 22 by further moving the cross head in the mold closing direction and the mold releasing (forcible mold opening) is executed. At the time, the molded product is separated from the stationary mold 21 and held on the movable mold 22 side. When the cross head 46 has been moved to the original position, the operation of the cross head 46 is stopped. Next, as illustrated in FIG. 6, the tie bar 17 is disengaged from the split nut 19 by opening the split nut 19 (engagement releasing step). As illustrated in FIG. 1, the movable platen 15, and the like are moved to a mold-opening retreat position by the mold opening-closing drive unit (mold opening step). When the cross head 46 is further moved in the mold closing direction from the state, the ejector pins 49 are projected from the mold mounting surface as illustrated in FIG. 10 to thereby operate an ejecting mechanism in the mold, so that the molded product is ejected from the movable mold 22 (ejecting step). The ejected molded product is transported to outside of the device by a taking-out unit, and the like. Thereafter, the cross head 46 is returned to the original position and a series of the molding cycles is completed. Subsequently, a next molding cycle is started. Note that, after the completion of ejecting, it is also possible to directly move the end block 16 to the position where the tie bar engaging groove 17a is meshed with the split nut engaging groove 19c of the split nut 19 without returning the cross head 46 to the original position once and to subsequently start the molding cycle. Further, at the time of mold opening, it is also possible to move the cross head 46 in the mold closing direction (right direction in FIG. 10) and to execute a product ejecting operation during a mold opening operation up to the mold-opening retreat position of the movable platen 15.

According to the mold clamping device 10 according to the first embodiment, since the toggle link mechanism 40 requires only the movement stroke necessary to the mold clamping, the mold releasing, and the ejecting, the right link 43 and the left link 44 are configured as a compact toggle link mechanism. Accordingly, the toggle link mechanism can be reduced in length as compared with an ordinary toggle link type mold clamping device for securing a mold opening-closing stroke and a mold clamping stroke of a movable platen and the like only by the stretching and contraction of a toggle link mechanism. With the configuration, a machine length of the mold clamping device (that is, a length of the mold opening-closing direction of the overall device) can be shortened, so that a space-saving machine can be configured. In contrast, although a conventional toggle link type mold clamping device such as the mold clamping device of Patent Literature 1 (JP 2000-110901 A) has an advantage in that it has boost characteristics for converting a small force to a large force by applying a principle of lever and is suitable for an electric drive type, the conventional device has a problem in that since a machine length becomes long, a large foot print is necessary in a factory.

Further, ordinarily, although the end plate (Patent Literature 1) and the end platen (Patent Literature 2) that are coupled with the toggle link mechanism are a single heavy member, since the mold clamping device 10 according to the first embodiment employs the four small end blocks 16 that are light in weight, a weight of the machine can be greatly reduced.

In the mold clamping device 10 according to the first embodiment, since the two toggle link mechanisms 40 are disposed to each of the four end blocks, the mold clamping device 10 has an excellent feature in that stress is uniformly distributed on a mold pairing surface and burrs are unlikely to be generated. That is, the mold clamping device 10 according to the first embodiment disperses the mold clamping force generated by the plurality of toggle link mechanisms 40 little by little and transmits the mold clamping force to the four corners of the movable platen 15 (that is, to the positions in the vicinities of the respective tie bars 17 in the movable platen 15). Accordingly, in the mold clamping device 10 according to the first embodiment, the movable platen 15 is flexed in its entirety when the molds are clamped to thereby reduce an amount of deformation due to the flexure of the movable platen 15, so that the mold clamping force acts on an overall mounting surface of the movable mold 22. Accordingly, since the stress is also uniformly distributed on the mold pairing surface, burrs are unlikely to be generated. Further, as illustrated in, for example, FIG. 3, when one of the two toggle link mechanisms 40 disposed to each end block 16 is disposed outside of the tie bar 17 and the other thereof is disposed inside of the tie bar 17, the stress on the mold pairing surface can be distributed more uniformly, thereby burrs can be prevented from being generated. In contrast, since the conventional mold clamping device, which secures the mold opening-closing stroke and the mold clamping stroke of the movable platen and the like only by the stretching and contraction of the toggle link mechanism, has such a structure that upper and lower two positions between an upper tie bar and a lower tie bar of a counter mold surface of the movable platen are ordinarily intensively pushed by two sets of toggle link mechanisms, the conventional device has a problem in that the movable platen is greatly flexed and deformed, a dispersion occurs in the distribution of stress generated on a mold pairing surface and it is likely that burrs are generated.

In the mold clamping device 10 according to the first embodiment, since the cross head 46 is supported by the movable platen 15, it is not necessary for the end block 16 to support the units such as the cross head and the like, thereby it is possible to make the end block 16 compact, simple, and light in weight. In contrast, in the conventional mold clamping devices such as the mold clamping devices of the Patent Literature 1 (JP 2000-110901 A) and Patent Literature 2 (JP 2001-300998 A), a cross head is supported by an end plate and the end plate is required to have a strength capable of supporting units such as the cross head and the like, which results in a problem that the end plate becomes greatly heavy.

Further, in the conventional mold clamping devices, to eject a molded product held by a movable mold by operating an ejector mechanism in the movable mold, an ejecting plate configured to project plural ejector pins from the movable platen and a drive mechanism of the ejecting plate are supported on a back surface side of the movable platen (side opposite to a mold mounting surface of the movable platen). In contrast, in the mold clamping device 10 according to the first embodiment, the cross head 46 includes the ejector pins 49 projecting toward the movable platen 15, the movable platen 15 has the holes, through which the ejector pins 49 can pass, at the positions where the holes are aligned with the ejector pins 49, and when the cross head 46 is moved in the mold closing direction and approached to the movable platen 15, the ejector pins 49 pass through the holes of the movable platen 15 and project from the movable platen 15. As described above, in the mold clamping device 10 according to the first embodiment, the ejecting plate and the cross head have a structure in which they are configured as a common component, it is sufficient to provide a set of the drive mechanism, so that the mold clamping device 10 has an excellent feature in that the number of parts and the number of man-hour necessary for assembly can be reduced and a manufacturing cost can be also reduced. Note that, in the mold clamping device 10 according to the first embodiment, the mold clamping step, the mold releasing step, and the ejecting step can be executed by operating only the cross head, the mold clamping device 10 is not restricted thereto and a structure in which an ejecting unit is separately provided may be employed. The ejecting unit can employ a hydraulic drive type or an electric drive type.

Further, as to the mold opening-closing drive unit, in the mold clamping device of Patent Literature 2, the end plate and the stationary platen or the movable platen and the stationary platen are coupled with each other by the mold opening-closing ball screw, and the end plate is moved in the mold opening-closing direction with respect to the stationary plate by driving the mold opening-closing ball screw. In contrast, the mold clamping device 10 according to the first embodiment further includes the machine base 11, the slide rails 73 disposed on the machine base 11, and the slide table 70 on which the movable platen 15 is mounted as well as which can slide on the slide rails 73, and the mold opening-closing drive unit couples the slide table 70 with the machine base 11 and moves the slide table 70 in the mold opening-closing direction with respect to the machine base 11 to thereby move the movable platen 15 in the mold opening-closing direction with respect to the stationary platen 14. As described above, since the mold clamping device 10 according to the first embodiment moves the slide table 70 on which the movable platen 15 is mounted with respect to the machine base 11, the mold clamping device 10 has an excellent feature in that a length of the mold opening-closing drive unit (mold opening-closing ball screw shaft 81) can be reduced.

### Second Embodiment

Next, FIG. 12 illustrates a second embodiment. A mold clamping device according to the second embodiment has a feature in that a plurality of end blocks are coupled with each other and a weight of the end blocks is supported by a slide table on which a movable platen is placed. Specifically, in the mold clamping device according to the second embodiment, each end blocks 16 in an up-down relation are coupled with each other by a coupling support member 76. Since coupling the end blocks 16 with each other allows the coupling support members 76 to receive a rotational force that is received by the end blocks 16 from large diameter link pins 47, no load (bending force) is applied to tie bars 17. Further, since a liner 71 is attached to a lower portion of each end block 16 on a lower side, the end block 16 can slide on the slide table 70. With the configuration, since weights of the respective end blocks 16 are supported by the slide table 70 and no weight is supported by the tie bars 17, the end blocks 16 can execute an operation more smoothly without being rubbed with the tie bars 17 in a mold opening-closing operation. The mold clamping device according to the second embodiment becomes heavier than the mold clamping device according to the first embodiment by a weight of the coupling support members 76. However, even if a weight of the four small and light end blocks 16 is added to a weight of the coupling support members 76, since a resultant weight is sufficiently smaller than that of one piece of the conventional end plate, a machine weight can be sufficiently reduced than the conventional mold clamping device.

### Third Embodiment

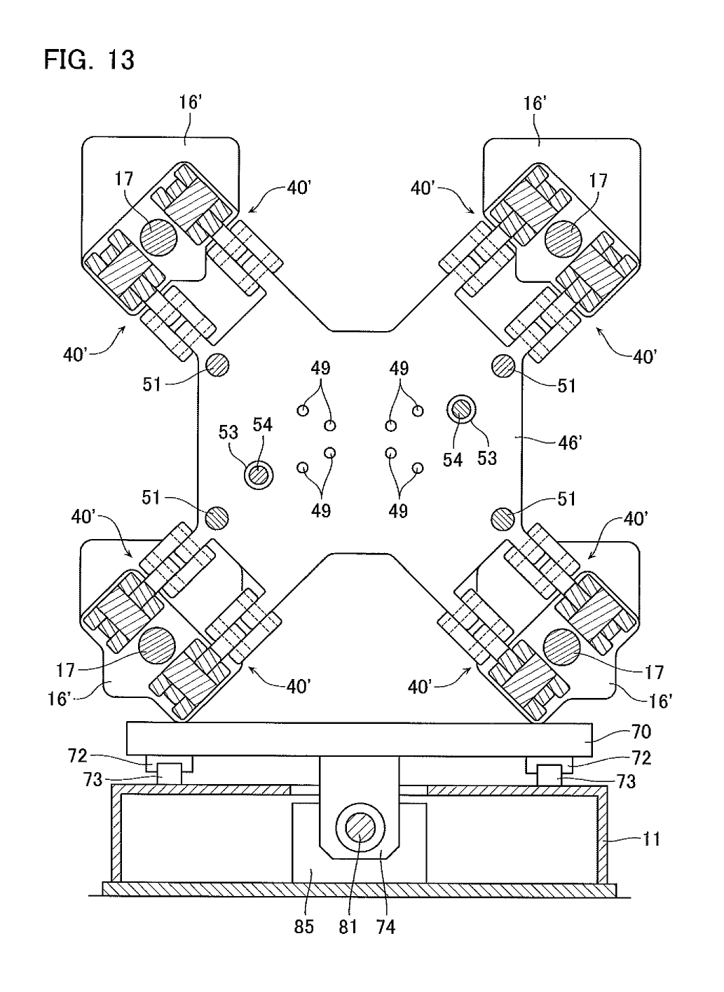

Finally, FIG. 13 illustrates a third embodiment. The third embodiment has such a structure that a cross head 46′ is coupled with end blocks 16′ from four oblique directions thereof via toggle link mechanisms 40′. With the structure, since the cross head 46′ can be reduced in size, a machine weight can be further reduced. Further, it is also possible to couple the end blocks 16′, which are located up and down, right and left, or diagonally with each other and further to support a weight thereof by the slide table 70 as in the second embodiment. Note that, although the number of tie bars 17 illustrated in FIG. 13 is four, it is also possible to set the number to three or five, and the like. In also FIG. 3, a mode that the right link 43 and the left link 44, which are located adjacent to each other across each tie bar 17, and the cross head links 45 are coupled with each other by a different member in a direction orthogonal to the axis direction of the tie bar 17 and a mode that the respective toggle link mechanisms 40′ disposed across the respective tie bars 17 are disposed on only any one side (a right side or a left side of the tie bars 17 in FIG. 13) may be employed likewise the first embodiment.

The embodiments described above are an example of the invention, the invention is not restricted by the embodiments and prescribed only by the matters described in claims, and embodiments other than the above embodiments can be executed.

For example, in the mold clamping devices according to the first to third embodiments, although one end block is disposed to each of the four tie bars, the invention is not restricted thereto and one end block may be disposed to, for example, two adjacent tie bars of the four tie bars by increasing a size of the end block. Further, one small-sized end block may be disposed to one tie bar of the four tie bars and one medium-sized end block may be disposed to the remaining three tie bars throughout them. Note that, since the split nut is disposed to each tie bar, when one end block is disposed throughout a plurality of tie bars, a plurality of split nuts are disposed to the one end block.

Further, in the mold clamping device according to the second embodiment, although the coupling support member 76 couples the end blocks 16 in the up-down relation with each other, the invention is not restricted thereto and may couple the end blocks 16 in a right-left relation. Further, the coupling support member 76 may couple the four end blocks in the up-down and right-left relations and may couple the end blocks located diagonally in the four end blocks.

### INDUSTRIAL APPLICABILITY

The mold clamping device and the ejecting method of the invention can be used in an injection molding machine and a diecast machine for molding a plastic product and an aluminum product of a car and an electric appliance.

### REFERENCE SIGNS LIST

10 mold clamping device

11 machine base

12 stationary key

14 stationary platen

15 movable platen

16 end block

17 tie bar

17a tie bar engaging groove

18 injection hole

19 split nut

19a right split nut

19b left split nut

19c split nut engaging groove

21 stationary mold

22 movable mold

30 stationary nut

31 sprocket

32 chain

34 idler sprocket

35 motor sprocket

40 toggle link mechanism

41 movable side link member

42 end side link member

43 right link

44 left link

45 cross head link

46 cross head

47 large diameter link pin

48 small diameter link pin

49 ejector pin

50 stationary plate

51 guide rod

52 guide rod nut

53 link portion ball screw nut

54 link portion ball screw shaft

55 link portion bearing

56 link portion support shaft receiver

61 large pulley

62 small pulley

63 toothed belt

64 motor bracket

65 drive servo motor

70 slide table

71 liner

72 slide block

73 slide rail

74 coupling block

76 coupling support member

81 mold opening-closing ball screw shaft

82 mold opening-closing ball screw nut

83 electromagnetic brake

84 support block

85 stationary block

86 coupling

87 mold opening-closing servo motor

90 split nut coupling block

91 ball screw shaft

91a right screw portion

91b left screw portion

92 right ball screw nut

93 left ball screw nut

94 stationary block

95 support block

96 coupling

97 nut opening-closing servo motor

1. A mold clamping device comprising:
a stationary platen having a surface to which a stationary mold can be mounted;
a movable platen having a surface to which a movable mold can be mounted, and the surface to which the movable mold can be mounted faces the surface to which the stationary mold of the stationary platen can be mounted;
a plurality of tie bars supported by the stationary platen and passing through the movable platen;
a plurality of end blocks each comprising at least one of split nuts capable of being engaged with and disengaged from one of the tie bars;
a plurality of mold clamping toggle link mechanisms at least one of which is provided to each of the end blocks and which couple the end blocks with the movable platen;
a cross head provided coupled with the mold clamping toggle link mechanisms for stretching and contracting the mold clamping toggle link mechanisms;
a mold opening-closing drive unit for moving the movable platen in a mold opening-closing direction with respect to the stationary platen; and
each of the end blocks being provided to each of the tie bars or provided to two or more adjacent tie bars of the tie bars.

2. The mold clamping device according to claim 1, wherein
the stationary platen and the movable platen are formed in a rectangular shape, and
the tie bars are supported at four corners of the stationary platen and provided passing through four corners of the movable platen.

3. The mold clamping device according to claim 1, wherein at least one of the mold clamping toggle link mechanisms is provided to each of the end blocks.

4. The mold clamping device according to claim 2, wherein at least one of the mold clamping toggle link mechanisms is provided to each of the end blocks.

5. The mold clamping device according to claim 1, wherein
the cross head is supported by the movable platen and comprises an ejector pin projecting toward the movable platen,
the movable platen has a hole through which the ejector pin can pass at a position aligned with the ejector pin, and
the ejector pin passes through the hole and projects from the movable platen by that the cross head moves in the direction of the movable platen and approaches the movable platen.

6. The mold clamping device according to claim 1, further comprising:
a machine base; and
a support member provided on the machine base for supporting the movable platen movably in the mold opening-closing direction with respect to the machine base,
wherein, the mold opening-closing drive unit directly couples the movable platen with the machine base or indirectly couples the movable platen with the machine base via the support member and moves the movable platen in the mold opening-closing direction with respect to the stationary platen by moving the movable platen in the mold opening-closing direction with respect to the machine base.

7. The mold clamping device according to claim 1, further comprising a coupling support member for coupling two or more end blocks of the end blocks with each other.

8. A molded product ejecting method executed using the mold clamping device according to claim 5, comprising:
a mold mounting step of mounting a stationary mold to the stationary platen and mounting a movable mold to the movable platen;
a mold closing step of moving the movable platen in the direction of the stationary platen by the mold opening-closing drive unit and closing the stationary mold and the movable mold;
an engaging step of engaging the tie bars with the end blocks by operating the split nuts, respectively after the mold closing step;
a mold clamping step of stretching the mold clamping toggle link mechanisms by moving the cross head in the direction of the end blocks after the engaging step and generating a mold clamping force between the stationary platen and the movable platen;
a molding step of molding a molded product in a mold cavity formed by the stationary mold and the movable mold after the mold clamping step;
a mold clamp releasing step of contracting the mold clamping toggle link mechanisms by moving the cross head in the direction of the movable platen after the molding step and releasing the molds clamped between the stationary platen and the movable platen;
an engagement releasing step of operating the split nuts, respectively after the mold clamp releasing step and disengaging the tie bars from the end blocks;
a mold opening step of moving the movable platen in the direction of the end blocks by the mold opening-closing drive unit in a state that the molded product is held by the movable mold after the engagement releasing step and opening the stationary mold and the movable mold; and
an ejecting step of projecting the ejector pin of the cross head from the hole of the movable platen by moving the cross head in the direction of the movable platen while the mold opening step is continued or after the mold opening step and ejecting the molded product held by the movable mold by the ejector pin.
